(19) United States
(12) Patent Application Publication
(10) Pub. No.: US 2004/0262295 A1
(43) Pub. Date: Dec. 30, 2004

(54) Fixing device

(75) Inventor: Yoshitsugu Nakatomi, Yokosuka-City (JP)

Correspondence Address: FOLEY AND LARDNER, SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 10/608,431

(22) Filed: Jun. 30, 2003

(51) Int. Cl. H05B 6/14; G03G 15/20

(52) U.S. Cl. 219/619; 399/330

(57) ABSTRACT

A covering member 59 having a heat accumulating member 60 capable of holding heat effectively secured thereto is provided, and the covering members 59 are disposed so as to surround a heating roller 52 on both ends of the heating roller 52 and both ends of the maximum paper width are disposed. The covering member 59 is formed of a heat insulating material, and the circumferences except the inner circumferential surface of the heat accumulating member 60 are covered by the covering members 59. Further, a covering member 79 having a heat generating member 80 secured thereto may be provided in place of the heat accumulating member 60.

### BACKGROUND OF THE INVENTION

1. Field of the Invention

The present invention relates to a fixing device disposed in an image forming apparatus which employs an electronic photographic process such as a laser printer, an electronic photographic-process copying machine, and so on.

2. Related Art Statement

In an image forming apparatus 1 which employs an electronic photographic process such as a laser printer, an electronic photographic-process copying machine, and so on, as shown in FIG. 1, first, the surface of a photosensitive body 2 is charged to a fixed surface potential by a charge-charger 3; and next, the surface of the photosensitive body 2 is exposed by an exposing device 4 such as a semiconductor laser or the like to attenuate the surface potential and form an electrostatic latent image. Then, a bias voltage is applied to the surface of a developing roller 6 of a developing device 5, toner charged in the developing device 5 is adhered and developed to an electrostatic latent image forming portion of the surface of the photosensitive body 2, and a toner image is formed on the surface of the photosensitive body 2.

On the other hand, a sheet of paper P is taken out of a paper cassette 7 by a feed roller 8, and the paper P is carried to a transfer area by a carrying roller 9. In the transfer area, the paper P is charged by a transfer charger 10, and the toner image formed on the surface of the photosensitive body 2 is transferred to the surface of the paper P. Next, the paper P is peeled from the surface of the photosensitive body 2 by a peeling charger 11, and carried to a fixing device 12. After the toner image has been fixed to the surface of the paper P by fixing rollers 13, 13, it is discharged outside the apparatus by a paper discharging roller 14.

The toner remained on the surface of the photosensitive body 2 after transfer is cleaned from the surface of the photosensitive body 2 by a cleaning blade 16, and is accumulated within a cleaner 15, after which it is recovered to a toner waste box.

As the above-described fixing device, there has been generally employed a fixing device 21 according to a thermal fixing system, as shown in FIG. 2, which has a heating roller 22 and a pressing roller 23, and in which the paper P is held between these rollers, and the paper P is heated and pressed to thereby fix a toner image on the surface of the paper P.

The heating roller 22 is a cylindrical pipe-like body made of iron having both ends thereof opened, and an induction heating coil 24 is disposed internally of the heating roller 22.

In the induction heating coil system, as shown in FIG. 3, the induction heating coil 24 is connected to a high frequency power source 25 to flow a high frequency current to the induction heating coil 24 whereby a magnetic field is generated in the circumference of the induction heating coil 24 to induce an eddy current into the heating roller 22. When the eddy current flows to the heating roller 22, Joule heat is generated by electric resistance of the heating roller 22 itself, thus enabling to heat the heating roller 22. This induction heating coil system has been widely utilized recently for the reasons that since the system heats the heating coil 24 itself directly, the heat efficiency is higher than the lamp system and heating can be done quickly to shorten the warming-up time, thus planning energy saving.

The pressing roller 23 is prepared by fusing a covering member made of rubber around a shaft made of metal.

Incidentally, in the conventional fixing device 21, as shown in FIG. 4, an effective heat generating portion of the induction heating coil 24 disposed internally of the heating roller 22 is positioned at an oblique-line area H which is somewhat wider than the maximum paper width W.

Further, both ends of the heating roller 22 are rotatably supported on frames 25, 26 of the fixing device 21 through bearings 27, 27, a gear 28 for driving the heating roller 22 is secured to one end of the heating roller 22, and the frames 25, 26, the bearings 27, 27 and the gear 28 used are made of steel in order to prevent thermal deformation.

As described above, since the effective heat generating portion of the induction heating coil 24 is merely somewhat wider than the maximum paper width, both ends of the heating roller 22 are not sufficiently heated; and since the frames 25, 26, the bearings 27, 27 and the gear 28 used are made of steel, heat is released easily by the heat conduction from both ends of the heating roller 22.

Therefore, the surface temperature T of the heating roller 22 is not even lengthwise, and is low on both ends, thus showing the temperature distribution as shown in FIG. 4.

Further, there occurred a problem that when printing is done continuously on paper which absorbs much heat such as thick paper, OHP paper or the like, heat is absorbed in these paper so that the surface temperature in both ends of the heating roller 22 becomes lower and lower.

A dominant cause is brought forth such that when the surface temperature in both ends of the heating roller 22 lowers, poor fixing occurs in both ends of paper to deteriorate image quality.

Further, there occurred a further problem such that when the poor fixing occurs, a non-fixed toner is adhered to the heating roller 22, the pressing roller 23, and further adhered to a cleaning roller, a cleaning felt, thus spoiling their function in a short period of time.

For solving these problems as noted above, the heating roller 22 and the effective heat generating portion of the induction heating coil 24 may be lengthened sufficiently as compared with the maximum paper width W. However, there occurred an inconvenience such that if doing so, the fixing device 21 becomes excessively large and. the image forming apparatus also becomes a large-type.

So, for preventing the surface temperature in both ends of the heating roller 22 without changing the length of the heating roller 22 and the effective heat generating portion of the induction heating coil 24 from being lowered, methods have been proposed in which 1) an induction heating coil is wound loosely in a central portion and closely in both ends; 3) a magnetic flux absorbing means is provided; and 2) an induction heating coil is made to be a double construction, as disclosed in Japanese Patent Laid-Open No. 29332/2000 Publication.

However, there occurred problems such that in the method of 1), it is difficult to wind the induction heating coil, and the steps of manufacturing increases to fabricate with good accuracy; in the method of 2), the step of mixing the magnetic flux absorbing means when a bobbin is manufactured is necessary, and the manufacturing steps increase also; and in the method of 3), there occurs a problem that a temperature control device for the second coil is necessary, leading to an increase in cost.

### SUMMARY OF THE INVENTION

The present invention has been accomplished in the light of problems as noted above with respect to prior art. An object of the invention is to provide a fixing device capable of effectively preventing the surface temperature in both ends of the heating roller from lowering and capable of manufacturing easily and inexpensively, without changing the length of the heating roller and the effective heat generating portion of the induction heating coil, that is, without making a fixing device a large-type.

For achieving the above-described object, a fixing device according to the present invention is characterized in that covering members having heat accumulating members capable of efficiently holding heat secured thereto are provided, and the covering members are disposed on both ends of a heating roller and both ends of the maximum paper width so as to surround the heating roller.

The present invention is further characterized in that covering members having a heat generating member secured thereto are provided, and the covering members are disposed on both ends of a heating roller and both ends of the maximum paper width so as to surround the heating roller.

### BRIEF DESCRIPTION OF THE DRAWINGS

FIG. 1 is a longitudinal sectional view of a conventional image forming apparatus;

FIG. 2 is a longitudinal sectional view of a conventional fixing device;

FIG. 3 is an explanatory view of an induction heating coil system;

FIG. 4 is a longitudinal sectional view of main parts of a conventional fixing device and a distribution view of surface temperatures of a heating roller;

FIG. 5 is a longitudinal sectional view of main parts of one embodiment of the fixing device of the present invention;

FIG. 6 is a perspective view of a covering member holding a heat accumulating member;

FIG. 7 is a sectional view taken on line A-A of FIG. 5;

FIG. 8 is an enlarged view of a B portion of FIG. 5;

FIG. 9 is a longitudinal sectional view of main parts of a further embodiment of the fixing device of the present invention;

FIG. 10 is a perspective view of a covering member holding a heat generating member;

FIG. 11 is a sectional view taken on line C-C of FIG. 9; and

FIG. 12 is an enlarged view of a D portion of FIG. 9.

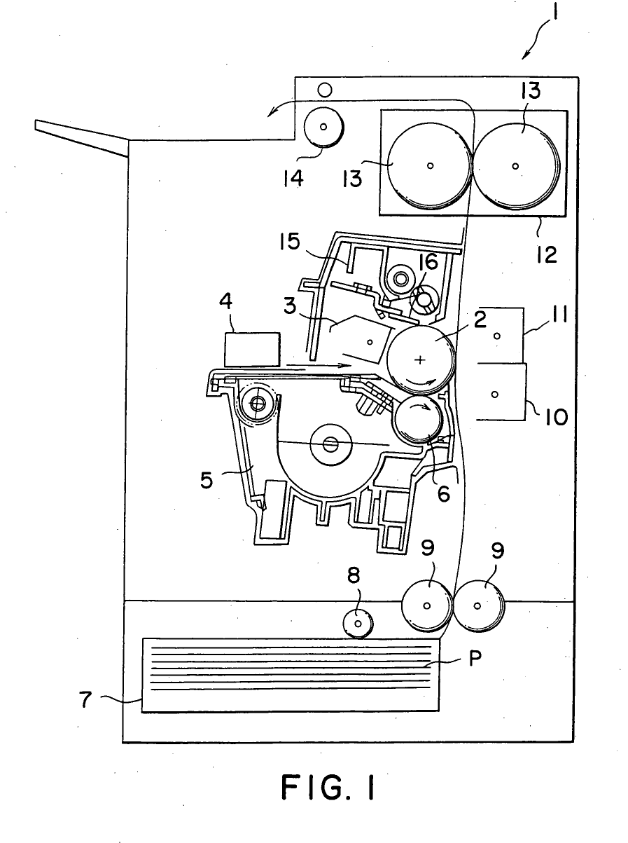

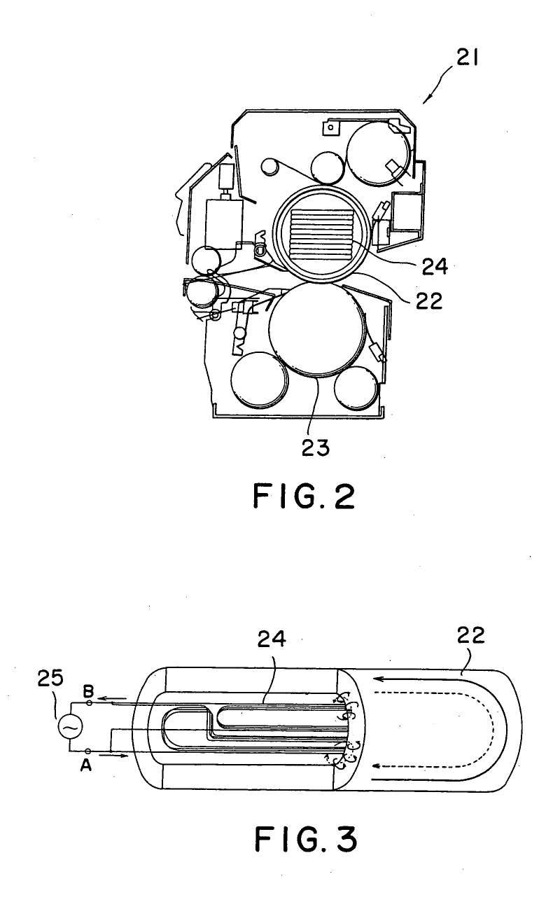

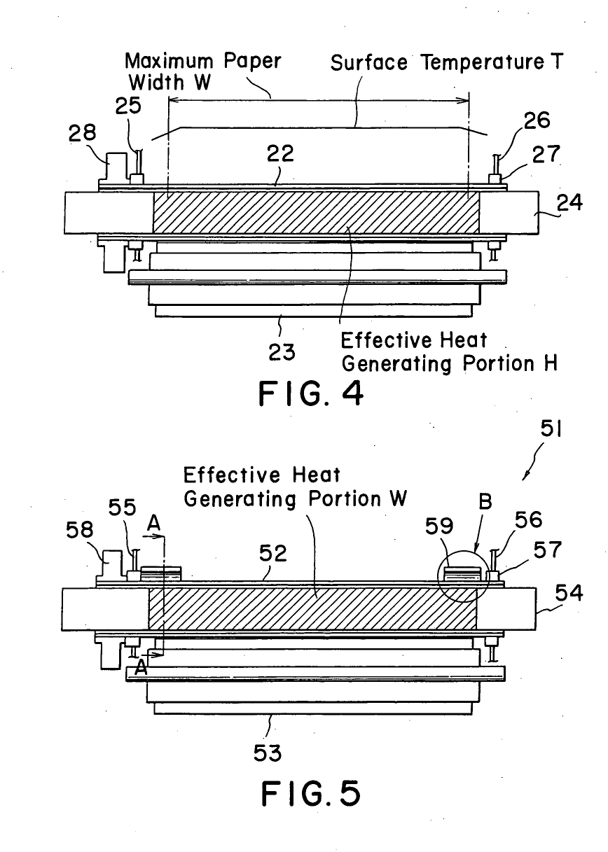

### DETAILED DESCRIPTION OF THE INVENTION

In the following, the embodiments of the fixing device according to the present invention will be described in detail with reference to the drawings.

### EXAMPLE 1

FIG. 5 is a longitudinal sectional view of main parts of one embodiment of the fixing device of the present invention. Also in this fixing device 51, the structure of a heating roller 52 and a pressing roller 53 is similar to that of the conventional fixing device 21. That is, an effective heat generating portion of an induction heating coil 54 disposed internally of the heating roller 52 is positioned at an oblique-line area H which is somewhat wider than the maximum paper width W, both ends of the heating roller 52 are rotatably supported on frames 55, 56 of the fixing device 51 through bearings 57, 57, and a gear 58 for driving the heating roller 52 is secured to one end of the heating roller 52.

The fixing device 51 of the present invention is different from the conventional fixing device 21 in that covering members 59 are disposed on the outer circumferences of both ends of the heating roller 52, as shown in FIG. 5.

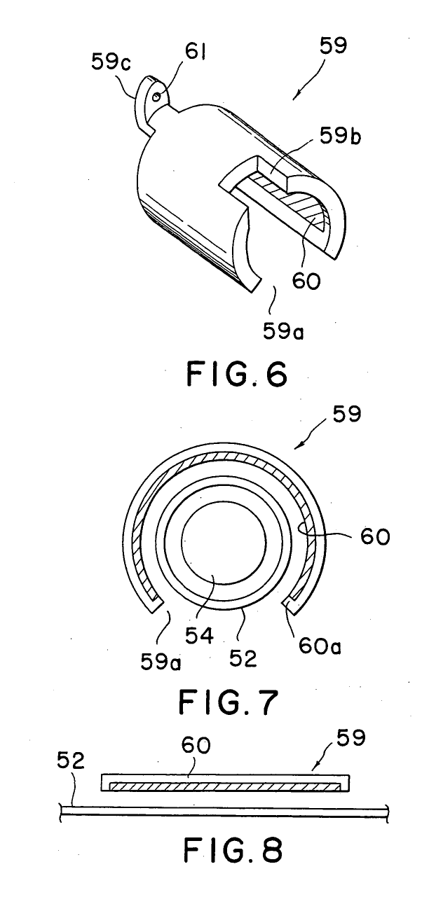

The covering member 59 is made of a heat insulating material such as plastic having a high heat insulating effect, and formed into a circular pipe-like body having an opening 59a, as shown in FIGS. 6 to 8. The length of the covering member 59 is not particularly limited, but is at least a length capable of covering an area where the surface temperature in both ends of the heating roller 52 lowers. Also, the opening 59a is formed so as not to interfere with the pressing roller 53 pressed on the heating roller 52, and the width of the opening 59a is preferably as narrow as possible as long as not to interfere.

A heat accumulating member 60 is secured to the inner circumferential surface of the covering member 59. The heat accumulating member 60 is made of a metal material such as brass, iron, etc. capable of efficiently holding heat, and is formed into a cylindrical body having an opening 60a corresponding to the covering member 59, as shown in FIGS. 6 to 8. In other words, circumferences except the inner circumferential surface of the heat accumulating member 60 are covered by the covering member 59 formed of a heat insulating material so as not to easily release heat held by the heat accumulating member 60, and the heat accumulating member 60 is held.

The covering member 59 is formed with a notch 59b opposite the opening 59a, and is formed with a mounting portion 59c having an insert hole 61 bored at the end thereof. The notch 59b is formed so as not to interfere with a cleaning roller for cleaning the heating roller 52, and the mounting portion 59c is formed to mount the covering member 59 on the frames 55, 56 of the fixing device 51.

The covering member 59, which is constituted as described above, is disposed so as to surround the heating roller 52 in the outer circumstances of the both ends of the heating roller 52, as shown in FIGS. 7 and 8. Here, preferably, for enhancing the heat accumulating effect, a clearance between the outer circumferential surface of the heating roller 52 and the inner circumferential surface of the heat accumulating member 60 is as narrow as possible.

In the fixing device 51 of the present invention, if a high frequency current is allowed to flow to the induction heating coil 54 to heat the heating roller 52, heat released in the both ends of the heating roller 52 is held by the heat accumulating member 60. The heat accumulating operation by the heat accumulating member 60 is carried out at the time of warming up at which the heating roller 52 is heated after the power source of the image forming apparatus has been turned ON, or when paper is not passed through the fixing device 51 during carrying paper and paper at the time of printing operation and so on.

Where paper passes through the fixing device 51, heat is released from both ends of the heating roller 52, and the surface temperature in both ends of the heating roller 52 lowers, that is, where a temperature difference occurs between the surface of both ends of the heating roller 52 and the heat accumulating member 60, heat is radiated on the surface of both ends of the heating roller 52 from the heat accumulating member 60, thus enabling to efficiently prevent lowering of the surface temperature in both ends of the heating roller 52.

Further, since the circumferences except the inner circumferential surface of the heat accumulating member 60 are covered by the covering member 59 made of a heat insulating material, heat held by the heat accumulating member 60 is not released easily, thus sufficiently exhibiting the heat accumulating effect.

### EXAMPLE 2

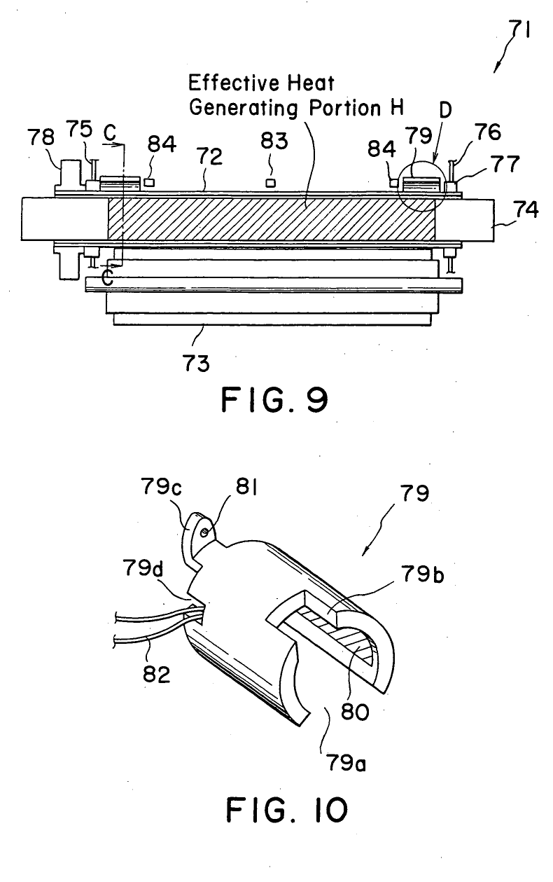

FIG. 9 is a longitudinal sectional view of main parts of a further embodiment of the fixing device of the present invention. Also in this fixing device 71, the structure of a heating roller 72 and a pressing roller 73 is similar to that of the conventional fixing device 21. That is, an effective heat generating portion of an induction heating coil 74 disposed internally of the heating roller 72 is positioned at an oblique-line area H which is somewhat wider than the maximum paper width W, both ends of the heating roller 72 are rotatably supported on frames 75, 76 of the fixing device 71 through bearings 77, 77, and a gear 78 for driving the heating roller 72 is secured to one end of the heating roller 72.

The fixing device 71 of the present invention is different from the conventional fixing device 21 in that covering members 79 are disposed on the outer circumferences of both ends of the heating roller 72, as shown in FIG. 9.

The covering member 79 is made of a heat insulating material such as plastic having a high heat insulating effect, and formed into a circular pipe-like body having an opening 79a, as shown in FIGS. 10 to 12. The length of the covering member 79 is not particularly limited, but is at least a length capable of covering an area where the surface temperature in both ends of the heating roller 72 lowers. The opening 79a is formed so as not to interfere with the pressing roller 73 pressed on the heating roller 72, and the width of the opening 79a is preferably as narrow as possible as long as not to interfere.

A heat generating member 80 is secured to the inner circumferential surface of the covering member 79. The heat generating member 80 is formed from a commercially available surface heat generating body, and is formed into a circular pipe-like body having an opening 80a, corresponding to the covering member 79, as shown in FIGS. 10 to 12, In other words, the circumferences except the inner circumferential surface of the heat generating member 80 are covered by the covering member 79 formed of a heat generating material, and the heat insulating member 80 is held so that the temperature of the heat-generated heat generating member 80 is not lowered easily.

The covering member 79 is formed with a notch 79b opposite the opening 79a, and is formed with a mounting portion 79c having an insert hole 81 bored at one end and a notch 79d. The notch 79b is formed so as not to interfere with a cleaning roller for cleaning the heating roller 72; the mounting portion 79c is formed to mount the covering member 79 on the frames 75, 76 of the fixing device 71; and the notch 79d is formed to draw out a lead wire 82 for applying a voltage to the heat generating member 80.

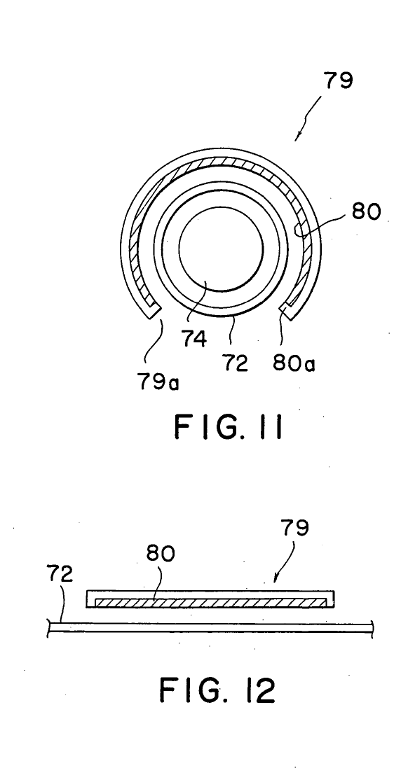

The covering member 79, which is constituted as described above, is disposed so as to surround the heating roller 72 in the outer circumference of both ends of the heating roller 72, as shown in FIGS. 11 and 12. Here, preferably, for enhancing the heating effect, a clearance between the outer circumferential surface of the heating roller 72 and the inner circumferential surface of the heat generating member 80 is as narrow as possible.

It is noted that in the present embodiment, for detecting the surface temperatures in the central portion and both ends of the heating roller 72, temperature sensors 83, 84 such as thermistors are provided on the surfaces of the central portion and both ends of the heating roller 72.

In the fixing device 71 of the present invention, if a high frequency current is allowed to flow to the induction heating coil 74 to heat the heating roller 72, the surface temperature of the heating roller 72 becomes high, but heating is not enough in both ends of the heating roller 72, and heat is released easily, thus the surface temperature becomes low.

Where paper passes through the fixing device 71, and heat is released from both ends of the heating roller 72 to lower the surface temperature in both ends of the heating roller 72, a degree of lowering of the surface temperature in both ends of the heating roller 72 is detected by the temperature sensors 83, 84. Thereby, a command is issued from a temperature control device (not shown) so that a voltage is applied to the heat generating member 80, heat generating member 80 generates heat, and the surfaces of both ends of the heating roller 72 are heated, whereby the lowering of the surface temperatures in both ends of the heating roller 72 can be prevented efficiently.

Further, since the circumferences except the inner circumferential surface of the heat generating member 80 are covered by the covering members 79 made of a heat insulating material, the temperature of the heat-generated heat generating member 80 is not lowered easily, and the rapid heating effect can be exhibited.

As described above, according to the fixing device of the present invention, since the lowering of the surface temperature in both ends of the heating roller can be prevented effectively, even in both ends of paper a toner can be sufficiently fixed, the image quality is not deteriorated, and the quantity of unfixed toner adhered to the heating roller, pressing roller, cleaning roller, and cleaning felt can be reduced to extend the service life thereof.

Further, according to the fixing device of the present invention, since the length of the heating roller and the effective heat generating portion of the induction heating coil need not be changed, no inconvenience occurs such that the fixing device is so large that the image forming apparatus is also larger-sized.

Furthermore, according to the fixing device of the present invention, since the covering member having the heat accumulating member or the heat generating member secured thereto is merely provided, the fixing device can be manufactured simply and inexpensively almost similar to that of prior art.

1. A fixing device employing an induction heating coil system, comprising: a heating roller having an induction heating coil disposed therein, a pressing roller for pressing said heating roller, and a covering member having a heat accumulating member capable of holding heat effectively secured thereto, characterized in that said covering members are disposed so as to surround said heating roller on both ends of said heating roller and both ends of the maximum paper width.

2. The fixing device according to claim 1, wherein the circumferences except the inner circumferential surface of said heat accumulating member are covered by said covering members made of a heat insulating material.

3. The fixing device according to claim 1, wherein said covering member is a circular pipe-like body having an opening.

4. A fixing device employing an induction heating coil system, comprising: a heating roller having an induction heating coil disposed therein, a pressing roller for pressing said heating roller, and a covering member having a heat generating member secured thereto, characterized in that said covering members are disposed so as to surround said heating roller on both ends of said heating roller and both ends of the maximum paper width.

5. The fixing device according to claim 4, wherein the circumferences except the inner circumferential surface of said heat generating member are covered by said covering members made of a heat insulating material.

6. The fixing device according to claim 4, wherein said covering member is a circular pipe-like body having an opening.

7. The fixing device according to claim 2, wherein said covering member is a circular pipe-like body having an opening.

8. The fixing device according to claim 5, wherein said covering member is a circular pipe-like body having an opening.
